(19) United States
(12) Patent Application Publication
(10) Pub. No.: US 2015/0008686 A1
(43) Pub. Date: Jan. 8, 2015

(54) Adjustable Vehicle Window Support Device

(71) Applicant: James Shearer, Jacksonville, FL (US)

(72) Inventor: James Shearer, Jacksonville, FL (US)

(21) Appl. No.: 14/246,204

(22) Filed: Apr. 7, 2014

Related U.S. Application Data
(60) Provisional application No. 61/842,476, filed on Jul. 3, 2013.

(51) Int. Cl. E05C 17/54

(52) U.S. Cl. CPC E05C 17/54
USPC 292/343

(57) ABSTRACT

Provided is a vehicle window support device comprising an elongated ladder strap and a locking wedge for attachment to a vehicle window to support the window in a desired position. The ladder strap has a top face and a rear face and at least one transverse ridge on its top face that engages with the locking wedge. The rear face of the ladder strap is capable of adhering to a vehicle window. The locking wedge has an upper end and a tapering lower end that enables the locking wedge to fit between a door sill and a vehicle window. The locking wedge further comprises a channel therethrough for accepting the ladder strap therein, wherein the channel allows the strap to lockably slide within the wedge while a ratcheting means within the wedge maintains the elongated strap in a desired position relative to the wedge.

### CROSS REFERENCE TO RELATED APPLICATION

This application claims the benefit of U.S. Provisional Application No. 61/842,476 filed on Jul. 3, 2013 entitled “Window Wedge.” The above identified patent application is herein incorporated by reference in its entirety to provide continuity of disclosure.

### BACKGROUND OF THE INVENTION

1. Field of the Invention

The present invention relates to vehicle windows and vehicle window support devices. More particularly, it pertains to a device for supporting a vehicle window having a broken or inoperative window regulator assembly, whereby the window can be supported within the window opening using a wedge supported between the window and the window sill.

Motor vehicles generally include a front windshield, a rear windshield, and side windows for each door. The side windows in a passenger vehicle utilize a mechanical system (commonly referred to as a window regulator) that enables each window to be independently opened and closed. This is accomplished with both manual and power systems. Manual windows utilize a crank that is rotated by a vehicle occupant to raise and lower the window. Many late model vehicles, however, utilize power windows, wherein an electric motor disposed within the door of the vehicle automatically raises and lowers the window when an activation button is activated.

While the mechanical elements that operate a vehicle window have become more reliable over time, they are still prone to failure. When failure occurs, the window is rendered inoperative. This is problematic when the electric motor fails and can no longer lower the window; however it is particularly problematic if the motor has failed with the window in a “down” position or if the physical support for the window fails. In the latter situations, the window often falls into the door interior and is not able to be raised and lowered using the regulator assembly. When this occurs, a temporary solution is required to seal the vehicle to prevent theft, water damage, and to provide protection from extreme climate situations.

Current solutions to seal a vehicle with an inoperative window involve taping a plastic bag or similar object over the window opening. As can be appreciated, a plastic bag provides little protection from theft. A thief can simply cut through the bag to access any items within the vehicle, or to steal the vehicle itself. Additionally, a plastic bag may obstruct the view out of the window, which can be particularly dangerous for the driver, as he or she may be prevented from using the side view mirrors. Further, plastic bags taped into position over a vehicle window tend to flap at highway speeds, which can be distracting to the driver and can cause excessive noise within the vehicle cabin.

The present invention overcomes the problems inherent in temporary vehicle window supports with a system that maintains an inoperative vehicle window in a desired position. The device comprises an elongated ladder strap and a locking wedge. The elongated ladder strap includes a plurality of transverse ridges that engage with the locking wedge. The locking wedge is adapted to fit between a door sill and a window in a vehicle. The ladder strap is maintained in a desired position with a ratcheting means. The elongated ladder strap is adhered to a vehicle interior window to lock the window at a desired position. The present invention supports the window at a desired height, which is suited for use with power or manually operated vehicle windows that are inoperative due to mechanical failure.

2. Description of the Prior Art

Devices have been disclosed in the prior art that relate to vehicle windows. These include devices that have been patented and published in patent application publications. These devices generally relate to apparatuses that wedge between a door sill and window within a vehicle. The following is a list of devices deemed most relevant to the present disclosure, which are herein described for the purposes of highlighting and differentiating the unique aspects of the present invention, and further highlighting the drawbacks existing in the prior art.

U.S. Pat. No. 5,988,712 to Segelin discloses an anti-theft device for a vehicle that includes an elongated rod that fits between a window glass pane and a facing inner edge of a window sill for an automobile door interior panel. A shield plate extends outward to one side of the rod at a distal end, and a wedge is fixed to and extends alongside the rod adjacent to the proximate end. By inserting the shield plate into the interior of the door within the gap and twisting the rod about the axis, the wedge is forced into a frictional locking position between the inside of the window glass pane and the window sill, with the shield plate covering the door mechanism actuating lever. This device, however, is adapted for preventing theft to a vehicle with an elongated rod and a hook. The present invention is designed to support a window when the mechanical components fail.

U.S. Pat. No. 4,932,100 to Elward discloses a wedge assembly that secures to a vehicle door to prevent door rattling during vehicle operation. The device comprises a slide element that is captured by a base plate and stops that are provided to prevent inadvertent disassembly. This device is designed to prevent a window from rattling, whereas the present invention prevents a window from falling into the door frame.

U.S. Pat. No. 6,364,289 to Cook discloses a locksmith's wedge for opening vehicle doors includes a tapered lower body and a channelized upper body. The tapered lower body is sized to slide between the outer wiper and outer surface of a vehicle's window, thereby separating the wiper from the window so that a locksmith's unlocking tool may be inserted. The '289 invention is designed to provide access to the interior of a vehicle when a key is not present.

U.S. Pat. No. 5,217,269 to Wiltberger discloses a portable handled door stop with an elongated rod, a handle a one end, and a wedge-shaped block at the other end of the rod. The rod extends for a length equal to the distance between the user's hand in the lowermost position of the arm and the floor with the user in an upright position. A molded plastic one-piece construction formed with a cross section similar to an I-beam. A non-skid surface is provided on the base of the unit. A hook-shaped projection at the top end of the door stop enables it to be stored when not in use. This device provides a door stop with an elongated handle. The present invention, however, is adapted for use in a vehicle for supporting a window.

The present invention is a new and improved vehicle window support device that provides a locking wedge capable of fitting between a vehicle window and a door sill, wherein an elongated ladder strap is adhered to a window interior surface that can slide within the locking wedge in order to adjust the height of the window relative to the sill. The wedge has a ratcheting means that engages the transverse ridges on the ladder strap, which allows the user to adjust the window to the desired height by adjusting the relative positioning of the ladders strap to the locking wedge.

It is submitted that the present invention is substantially divergent in design elements from the prior art, and consequently it is clear that there is a need in the art for an improvement to existing vehicle window support devices that are capable of supporting a window whose regulator has become malfunctioning or broken. In this regard the instant invention substantially fulfills these needs.

### SUMMARY OF THE INVENTION

In view of the foregoing disadvantages inherent in the known types of vehicle window support devices now present in the prior art, the present invention provides a new vehicle window support device wherein the same can be utilized for providing convenience to the user when the mechanical means for operating a vehicle window are broken or inoperable.

It is therefore an object of the present invention to provide a new and improved vehicle window support device that has all of the advantages of the prior art and none of the disadvantages.

It is another object of the present invention to provide a vehicle window support device that can attach to a vehicle window and maintain the vehicle window in a particular position.

Another object of the present invention is to provide a vehicle window support device having an elongated ladder strap and a locking wedge that can support a vehicle window at a desired height.

Yet another object of the present invention is to provide a vehicle support device having an elongated ladder strap and a locking wedge wherein the elongated ladder strap has a stop block at its upper end to prevent the vehicle window from sliding down into the door panel.

The vehicle window support device may be readily fabricated from materials that permit relative economy and are commensurate with durability. Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the present invention.

FIG. 2A shows a perspective view of the locking wedge.

FIG. 2B shows a side view of the elongated strap within the locking wedge wherein the side panel is removed.

FIG. 3 shows an underside view of the elongated ladder strap positioned within the locking wedge.

FIG. 4 shows a perspective view of the rear face of the elongated ladder strap with the adhesive partially exposed.

FIG. 5A shows a perspective view of the elongated ladder strap with a stop block installed at the first end.

FIG. 5B shows a perspective view of the elongated ladder strap without a stop block installed on the first end.

FIG. 6 shows a view of the present invention installed on a vehicle window.

FIG. 7 shows a view of the present invention installed on a vehicle window.

### DETAILED DESCRIPTION OF THE INVENTION

Reference is made herein to the attached drawings. Like reference numerals are used throughout the drawings to depict like or similar elements of the vehicle window support device. For the purposes of presenting a brief and clear description of the present invention, the preferred embodiment will be discussed as used for supporting a vehicle window with a broken or inoperative mechanical system at a variety of heights. The figures are intended for representative purposes only and should not be considered to be limiting in any respect.

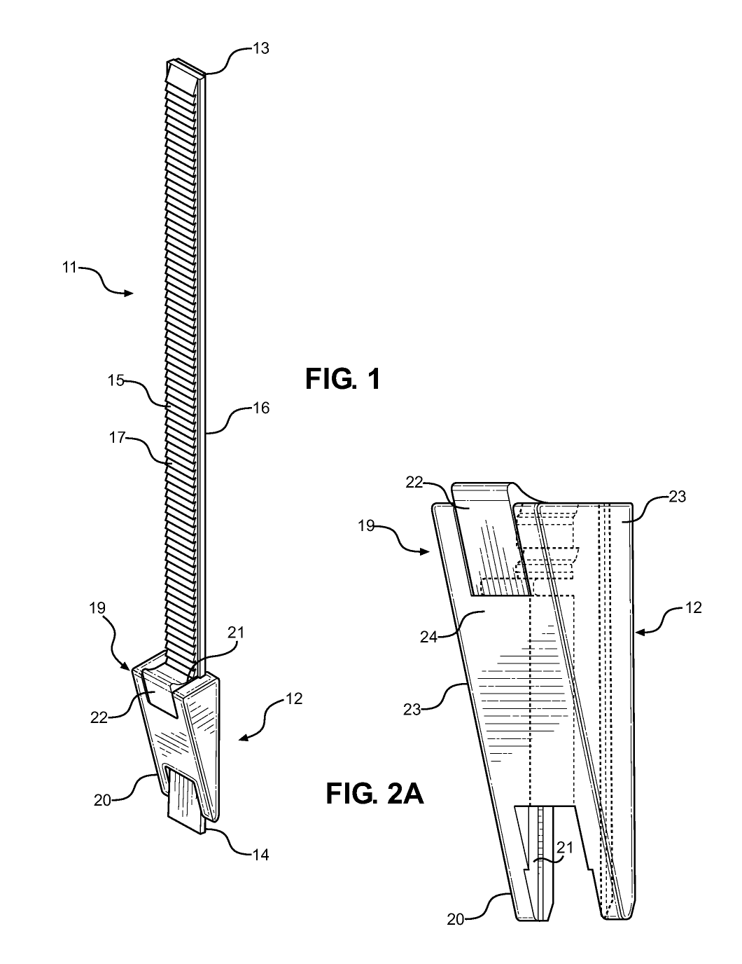

Referring now to FIG. 1, there is shown a perspective view of the present invention. The device comprises an elongated ladder strap 11, and a locking wedge, 12. The elongated ladder strap includes a first end 13, a second end 14, a top face 15, and rear face 16. The top face includes one or more transverse ridges 17 that engage with the locking wedge 12. The locking wedge 12 includes an upper end 19 and a lower end 20, wherein the locking wedge 12 tapers from the upper end 19 to the lower end 20. The taper creates a wedge shaped configuration that is adapted to fit between a door sill and a window in a vehicle. The locking wedge 12 further includes a channel 21 that accepts the elongated ladder strap 11 and enables the strap to slide within the locking wedge. The ladder strap 11 is maintained in a desired position with the use of a ratcheting means 22. The elongated ladder strap can be adhered to the interior window within a vehicle and the locking wedge can engage with the ladder strap. The ratcheting means can then be used to lock the window at a desired position.

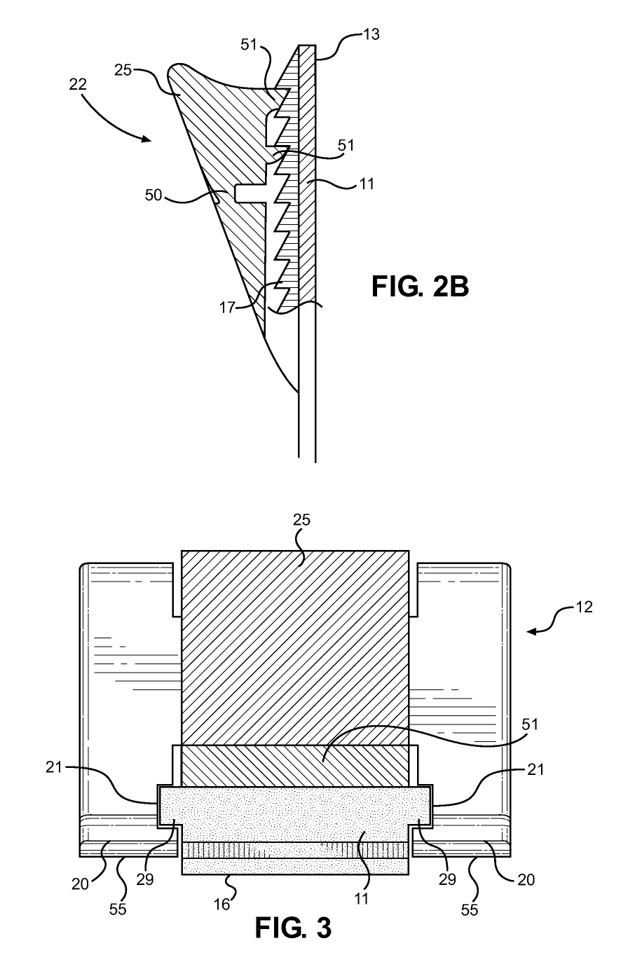

Referring now to FIG. 2A, there is shown a perspective view of the locking wedge. The locking wedge 12 comprises an upper end 19, a lower end 20, a channel 21, and a ratcheting means 22. The wedge tapers from the upper end 19 to the lower end 20. The taper creates a wedge shape that fits between a door sill and window in a vehicle. The wedge is preferably constructed of a pair of side brackets 23, which are connected by a support bridge 24. The side brackets 23 and support bridge 24 are preferably a monolithic structure that provides an open volume between the side brackets 23 for placement of the ladder strap. The ladder strap comprises extension wings that are adapted to engage with the channel 21 of the wedge, whereby the strap can slide controllably therein and the ridges of the strap align with the ratcheting means 22 of the wedge.

The ratcheting means 22 is disposed on the upper end 19 of the locking wedge 12. In the preferred embodiment, the locking wedge 12 comprises a pawl 25 that engages with the transverse ridges on the elongated ladder strap. The pawl 25 is attached to the locking wedge 12, either via a flexible connection or via a pin that enables the pawl 25 to rotate away from the strap and thus allow the paw to slidably engage one set of the transverse ridges at a time, thereby allow upward moving the ladder strap to a higher via sliding motion and locking the strap at each ridge position when the pawl 25 is pressed thereagainst. When the paw 25 is manually rotated away from the strap, the strap can slide downwards through the wedge 12 to a lower position. The pawl 25 includes one or more teeth that catch the transverse ridges of the ladder strap, thereby locking the pawl 25 against the teeth and preventing any further motion of the wedge 12 in that direction.

The top of the pawl is preferably curved upwards and includes a textured surface to enable a user to engage the pawl. A finger or thumb can move the pawl away from the ladder strap to change its position. In a first embodiment, the pawl can be manually moved into and out of position via its attachment to the wedge for adjusting the height of the elongated ladder strap. In a second embodiment, the pawl can be spring-loaded, wherein a spring forces the pawl back into position against the transverse ridges. The preferred embodiment comprises a flexible connection between the pawl and the wedge, whereby the flexible connection is inherently biased towards the strap, but can be withdrawn to allow the strap to slide therethrough. Other embodiments contemplate a pin connection or a spring loaded pawl.

Referring now to FIG. 2B, there is shown a cross sectional side view of the elongated strap within the locking wedge. The preferred embodiment is illustrated in this figure, wherein the ratcheting means 22 comprises a pawl 25 having teeth 51 and the pawl 25 is secured to the wedge via a flexible connection 50. The pawl may have one or more teeth 51 that are capable of engaging with the ladder strap 11. The pawl 25 pivots about the flexible connection such that the pawl 25 can be positioned so as to allow the ladder strap 11 to slide up and down within the locking wedge 12. The user first releases the pawl 25 to allow the strap 11 to move freely within the wedge to adjust the relative positioning of the wedge and strap. Once the desired position of the strap (and thus the vehicle window height) is achieved, the user releases the pawl 25, wherein the flexible connection 50 biases the pawl towards the wedge channel and the strap ridges 17 so as to hold the window in place at the height desired. It is contemplated that the flexible connection 50 may be substituted by a pin joint connection or a spring biased pin connection, thereby achieving the same ends as the flexible connection in biasing the teeth 51 of the pawl towards the strap 11 when the strap is inserted therethrough.

Referring now to FIG. 3, there is shown an underside view of the elongated ladder strap positioned within the locking wedge 12, wherein the lower end 20 of the wedge is shown. The elongated ladder strap 11 comprises a first end 13, a second end 14, a top face 15, and rear face 16. The top face 15 of the ladder strap preferably includes a plurality of transverse ridges 17 along the length thereof, in which the teeth 51 of the pawl 25 engage therewith. When together, the rear face 16 of the ladder strap 11 is adapted to be pressed against a window glass surface while the wedge slides therealong. The rear face 16 is offset from the body of the ladder strap such that it makes contact with the window glass and the wedge rear surface 55 does not present an interference with this attachment.

The ladder strap further comprises a pair of extension wings 29 that provide a portion for engaging with the channel 21 of the locking wedge 12. The extension wings 29 extend outward, thereby locking the ladder strap within the channel of the locking wedge while still allowing the ladder strap to travel along the length of the locking wedge. The channels 21 extend along the length of the side brackets 23. The positioning of the channel 21 enables the locking wedge to rest flush against the surface of the vehicle window or slightly separated therefrom when installed therein, while also allowing the rear face 16 of the strap to maintain connection with the window surface. The wedge is adapted to be positioned and abutted between the door sill and window within a vehicle, and the ladder strap is positioned such that the wing extensions 29 engage with the channels 21 within the locking wedge. This enables the ladder strap to slide within the wedge until the transverse ridges make contact with the pawl 25, thereby locking the ladder strap in position.

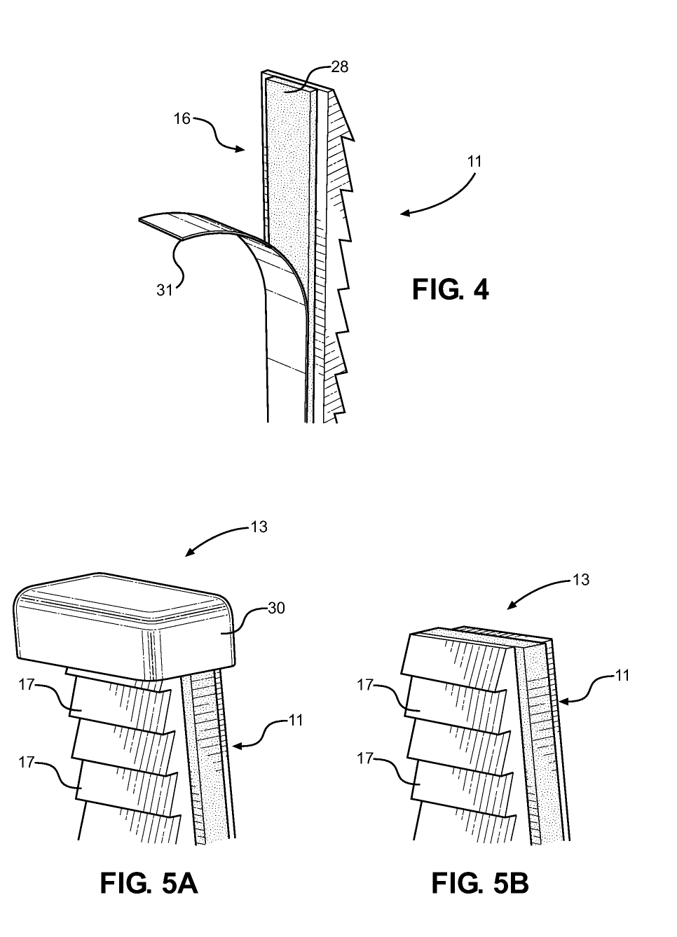

Referring now to FIG. 4, there is shown a perspective view of the rear face of the elongated ladder strap 11 with the adhesive partially exposed. The rear face 16 includes a means of adhering the ladder strap to the interior surface of a window. In the preferred embodiment, the rear face includes an adhesive material 28 disposed along a portion thereof. The adhesive may comprise a double sided tape, adhesive foam tape, or a similar substance that includes adhesive adapted to secure the ladder strap to straight or curved window glass. In the embodiment shown in FIG. 4, the rear face 16 further comprises a removable backing strip 31 or film, which extends along the length of the adhesive material 28 in order to cover and protect the adhesive material until the elongated strap until the time when the elongated strap 11 is attached to a vehicle window.

Referring now to FIG. 5A, there is shown a perspective view of the elongated ladder strap with a stop block 30 installed at the first end 13. In some embodiments, the elongated ladder strap 11 may include a stop block 30 disposed on the first end, which is an enlarged geometric object that expands the cross section of the strap 11 at the first end 13. The block 30 is intended to prevent the elongated strap 11 from sliding all the way through the locking wedge when the pawl is disengaged from the transverse ridges 17. The block 30 further provides a handle portion in which the user can grip the ladder strap 11 after being attached to the window glass, whereby the user can lift the ladder strap 11 and glass by the block 30 when adjusting the window glass position. In this way the block serves dual purposes.

As can be appreciated, when the mechanical element of the window system is broken or inoperative, the weight of a vehicle window will cause it to move down and into the door of a vehicle. When this occurs, there is often no portion of the window available to grasp to return the window to the “up” position. In such situations, disassembly of the door panel and/or door is generally required to access the window. This can occur even with the present invention installed within a vehicle. If the pawl is released and the window is not supported by the user, the window can slide all the way into the door, rendering it inaccessible.

The stop block prevents the window from sliding all the way into the door. The stop block is larger than channel within the locking wedge, which prevents the ladder strap from sliding entirely through the locking wedge. If the pawl is released and the window is allowed to freely slide, the window will slide until the stop block makes contact with the upper end of the locking wedge. This disposes a portion of the window above the door sill to enable a user to return the window to a desired position without requiring disassembly of the door and/or door panel.

Referring now to FIG. 5B, there is shown a perspective view of the elongated ladder strap without a stop block installed on the first end 13. In some embodiments, the elongated ladder strap 11 does not include a stop block disposed on the first end 13. In these embodiments, the traverse ridges 17 extend along the length of the elongated strap 11.

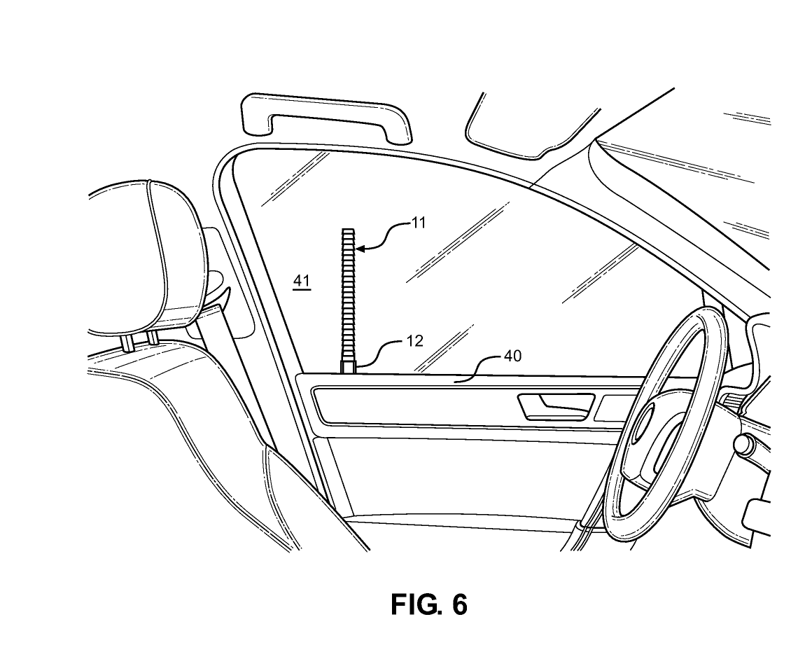

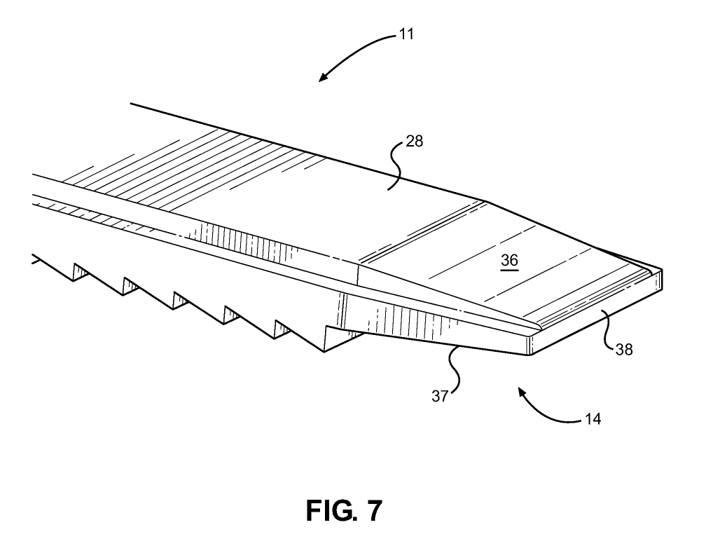

Referring now to FIG. 6, there is shown a view of the present invention installed on a vehicle window. In operation, the locking wedge 12 can be secured between the door sill 40 and window 41 of a vehicle. The elongated ladder strap 11 can then be inserted into the channel within the locking wedge. The adhesive on the rear face of the ladder strap can be adhered to the window, and the device can be used to lock the window at a desired height. Alternately, the ladder strap can engage with the locking wedge prior to installation on the vehicle window. The ladder strap 11 can be adhered to the window 41 and the locking wedge 12 can be positioned between the door sill 40 and window 41 by sliding the locking wedge 12 down the ladder strap 11 or by lowering the window until contact is made.

Once installed, the window can be moved vertically by manually lifting the window towards the roof of the vehicle. The pawl of the locking wedge allows the transverse ridges on the ladder strap to move vertically within the channel. Once a desired height is reached, the pawl engages with the transverse ridges and locks the window at the desired height. The taper of the locking wedge prevents the wedge, ladder strap, and window from sliding down and into the door sill. To lower the window, the pawl is moved away from the ladder strap via the pin, which disengages the pawl from the transverse ridges. The window can then be gradually lowered to a desired height and the pawl can be moved back into position to engage with the transverse ridges, once again locking the window at a desired height.

Referring finally to FIG. 7, there is shown a preferred embodiment of the second end 14 of the ladder strap 11. The second end 14 is the portion of the strap 11 that is adapted to be inserted through the locking wedge and slide between the window glass and the door sill in operation. Therefore, to facilitate this insertion between portions of the vehicle in which clearance may be an issue, it is contemplated that the second end 14 taper to a smaller cross section. As illustrated, the adhesive material 28 tapers along a rear tapering surface 36, while the front face of the ladder strap similarly tapers along a frontal tapering surface 37. These two tapering surfaces converge at a tip 38 that has an end surface area or cross sectional area that is smaller than the cross sectional area of the ladder strap along its free field length and average cross sectional area. This reduces the resistance on the strap when penetrating the gap between the window glass and the door sill, reducing required force to accomplish this task and preventing potential damage to the sill in the process.

Overall, the present invention provides a convenient solution for vehicles with broken or inoperative window system. The device locks the window at a various heights, from completely open to completely closed. In addition, the transverse ridges and pawl enable adjustment of the height, thereby enabling a user to raise and lower the window as needed. The device can be used as a temporary solution until the mechanical elements in a window system can be repaired, or as a permanent fix if repair is impractical or impossible.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An attachment for a window within a vehicle for maintaining the window in a desired position, comprising:
an elongated ladder strap and a locking wedge;
said elongated ladder strap comprising a first end, a second end, a top face, and a rear face;
said top face comprising at least one transverse ridge that is adapted to engage with said locking wedge;
said elongated ladder strap further comprising an adhesive disposed along a portion of said rear face;
said locking wedge comprising a upper end and a lower end, wherein said locking wedge tapers from said upper end to said lower end;
said locking wedge lower end being adapted to be abutted between a door sill and a window in a vehicle;
said locking wedge further comprising a channel that accepts said ladder strap and enables said strap to slide within said locking wedge, and a ratcheting means for maintaining said ladder strap in a desired position.

2) The device of claim 1, wherein said locking wedge comprises a first side bracket and a second side bracket, wherein said first side bracket and second side bracket are attached by a bridge support so as to create an open volume within said locking wedge for placement of said ladder strap.

3) The device of claim 1, wherein:
said ratcheting means comprises a pawl having one or more teeth that are capable of engaging said transverse ridges on said ladder strap, said pawl being rotatably attached to said locking wedge and biased towards said channel.

4) The device of claim 1, wherein:
said ratcheting means comprises a pawl having one or more teeth that are capable of engaging said transverse ridges on said ladder strap;
said pawl being attached to said locking wedge via a flexible connection that biases said pawl towards said channel.

5) The device of claim 1, wherein:
said ratcheting means comprises a pawl having one or more teeth that are capable of engaging said transverse ridges on said ladder strap;
said pawl being attached to said locking wedge via a spring biased pin connection that biases said pawl towards said channel.

6) The device of claim 1, wherein said channel extends along the length of said side brackets, wherein said channel is positioned such that said locking wedge is capable of resting substantially against a surface of a vehicle window while said elongated ladder strap rear face is attached thereto.

7) The device of claim 1, further comprising a stop block disposed on said first end of said ladder strap, wherein said stop block prevents said ladder strap from passing through said channel in said locking wedge.

8) The device of claim 1, wherein said second end of said ladder strap further comprises:
a rear tapering surface and a frontal tapering surface;
said front tapering surface and said rear tapering surfaces converging at a tip having a reduced smaller cross sectional area.

9) The device of claim 1, wherein said ladder strap further comprises extension wings that extend outward from the sides of said ladder strap, said extension wings adapted to slide within the channel of the locking wedge.

10) An attachment for a window within a vehicle for maintaining the window in a desired position, comprising:
a locking wedge having an upper end and a lower end, wherein said locking wedge tapers from said upper end to said lower end;
said locking wedge lower end being adapted to be abutted between a door sill and a window in a vehicle.

11) The device of claim 10, wherein said locking wedge comprises a first side bracket and a second side bracket, wherein said first side bracket and second side bracket are attached by a bridge support so as to create an open volume within said locking wedge.

12) The device of claim 10, wherein:
said ratcheting means of said locking wedge comprises a pawl having one or more teeth;
said pawl being rotatably attached to said locking wedge and biased towards said channel.

13) The device of claim 10, wherein:
said ratcheting means of said locking wedge comprises a pawl having one or more teeth;
said pawl being attached to said locking wedge via a flexible connection that biases said pawl towards said channel.

14) The device of claim 10, wherein said channel extends along the length of said side brackets.

15) An attachment for a window within a vehicle for maintaining the window in a desired position, comprising:
an elongated ladder strap having a first end, a second end, a top face, and a rear face;
said top face comprising at least one transverse ridge;
said elongated ladder strap further comprising an adhesive disposed along a portion of said rear face.

16) The device of claim 15, further comprising a stop block disposed on the first end of said ladder strap.

17) The device of claim 15, wherein said ladder strap further comprises extension wings that extend outward from the sides of said ladder strap.

18) The device of claim 15, wherein said second end of said ladder strap further comprises:
a rear tapering surface and a frontal tapering surface;
said front tapering surface and said rear tapering surfaces converging at a tip having a reduced smaller cross sectional area.
